(19) United States
(12) Patent Application Publication
(10) Pub. No.: US 2004/0028225 A1
(43) Pub. Date: Feb. 12, 2004

(54) Anti-forgery and anti-theft system, particularly for secured documents

(75) Inventor: Uwe Weber, Hamburg (DE)

Correspondence Address: DARBY & DARBY P.C., P. O. BOX 5257, NEW YORK, NY, 10150-5257, US

(73) Assignee: Bundesdruckerei GmbH, Berlin (DE)

(21) Appl. No.: 10/394,483

(22) Filed: Mar. 21, 2003

Related U.S. Application Data
(63) Continuation of application No. PCT/EP01/09914, filed on Aug. 29, 2001.

(30) Foreign Application Priority Data
Sep. 21, 2000 (DE) 100 46 710.5

(51) Int. Cl. G09C 5/00

(52) U.S. Cl. 380/54

(57) ABSTRACT

An anti forgery and/or anti-theft system is disclosed for use with documents and things. An LCR oscillating circuit is printed on or embedded in the document or thing. Because of the resistance, when the oscillating circuit is placed in a suitable high frequency electromagnetic field, heat is generated due to the power dissipated in the resistor. The heat can be used to cause a change in color of a thermochromic pigment, or the heat can be detected by a suitable thermographic measuring device such as an infrared video camera.

This is a continuation of International Patent Application No. PCT/EP01/09914, filed Aug. 29, 2001 and claims the benefit of German Patent Application No. 100 46 710.5, filed Sep. 21, 2000. The International application was published in German on Mar. 28, 2002, publication No. WO 02/25600 under PCT article No. 21(2).

This invention relates to an anti-forgery and/or anti-theft system for use with documents and things of all types.

### BACKGROUND OF THE INVENTION

There are many different types of documents and things which are subject to forgery and/or theft. By way of example only, such documents include bank notes, identification papers, passports, drivers licenses, visas, admission tickets and stock certificates. As used herein, the term “secured document” includes any document or thing which is provided with a distinguishing authenticity element (whether printed or not) which can be used to prevent forgery, authenticate, identify or classify the document. The term “authenticity element” is intended to refer to any “device” which may be printed on, or otherwise attached to, a secured document for the purpose of authenticating the document, for the purpose of determining its value and/or type, or any other characteristic, or for preventing forgery. Likewise, “authenticity” is meant to encompass value, type or other characteristic of a secured document, as well as the genuineness of the document.

AT 362 658 discloses a secured document, a method for testing the secured document, and a device for implementing the test method. The authenticity element comprises a thermochromatic pigment dye printed on the document or distributed within the paper mass. If a predetermined temperature is exceeded, the color of the thermochromatic pigment dye is reversibly changed. A substance which can be heated by electromagnetic oscillations of at least 10 kHz, is introduced into the pigment dye in powder form as an electrically conductive substance.

DE 196 29 024 A1 discloses a film material for representing the spatial distribution of high-frequency electromagnetic radiation in the EMV range (the range of electromagnetic energy to which humans can be safely exposed). The material has a carrier material, a base material, an HF absorption material, a thermo-optically active material, a tempering layer and a polarization film. If an electromagnetic radiation irradiates the film, the radiation is absorbed in the absorption material and converted to heat. In other words, a high-frequency electromagnetic radiation is introduced into the material, which develops heat by means of absorption, and this heat then causes a color change.

DE 29 19 649 shows a secured document consisting of a paper sheet and a carrier. The carrier is provided with an electronic circuit structured using thin-film technology. The circuit is not described in greater detail. This electronic circuit allegedly allows an appropriate coding of the secured document which thereby increases the security against forgery. The electronic circuit can comprise resistors, capacitors, transistors, diodes in the form of integrated circuits, or hybrid circuits.

It is the object of the present invention to provide a cost-effective, flexible and reliable authenticity system for secured documents which is extremely difficult to forge and is capable also of deterring theft of the secured document.

### SUMMARY OF THE INVENTION

According to the invention, at least one LCR oscillating circuit is applied to a secured document as an authenticity element. The circuit produces heat when excited by an electromagnetic radiation source due to the power dissipation. The heat can be determined directly or by way of a specific indicator reaction.

The electromagnetic radiation source preferably is a high-frequency radiation source and emits radiation in the megahertz frequency range.

The specific indicator reaction can be provided, for example, by means of color pigments which are actuated by the heat, to reversibly or irreversibly produce a color change. This color change is visible to the eye of an examiner, if necessary using optical magnifiers, or the color change can be determined by means of an automated measuring device.

In another embodiment of the invention, the heat generated by the power dissipation of the LCR oscillating circuit is directly evaluated by a thermographic measuring device, without any color pigments being provided within the secured document.

In both embodiments of the invention, the LCR oscillating circuit on the secured document is excited by an external high-frequency transmitter, the secured document with the LCR oscillating circuit being introduced into the electromagnetic field of the transmitter. This causes the LCR oscillating circuit to produce independent, attenuated oscillations, thereby producing a corresponding power dissipation. The power dissipation is transferred to the secured document in the form of heat which spreads within the document.

This high-frequency transmitter therefore also acts as a testing device, and can include an integrated thermographic measuring device if no color pigments are provided within the secured document, with the power dissipation directly recorded by means of the thermographic measuring device.

By providing the LCR oscillating circuit, it is possible to create a cost-effective anti-forgery device and, at the same time, an anti-theft device, by means of a combination of passive electronic components such as an inductor, a capacitor, and a resistor. For this purpose, the LCR oscillating circuit(s) can be applied to the secured document by various printing techniques.

Because of the resistor in the LCR oscillating circuit combination, it is possible to produce individual security characteristics. For example, since the power dissipation is a function of the resistance of the resistor, the heat produced per unit time can be determined. If a color change of color pigments by means of the power dissipation of the resistor is provided, a specific color change can be achieved, which can be determined with the eye or by means of measuring devices. This provides a high level of security against forgery and theft. Even without a color change of color pigments, the temperature change of the secured document can be precisely determined by means of thermographic measuring devices. Here also, the level of security against forgery and theft is high.

An advantage of the present invention is that the oscillating circuit function can be coordinated in such a way, that the LCR combination can be used with commercially available anti-theft devices in the MHz range.

The LCR oscillating circuit combination has an additional function which makes it possible to cause a hidden product identification to be visible. A power dissipation that generates heat and radiates it to the surroundings will be formed in the resistor of the oscillating circuit if excited by a hand-held device that emits radio frequency energy to the oscillating circuit components, located (for example) in a film of the secured document, for example at a distance of less than 1 mm from the document.

The heat of the resistor can be conducted directly to a temperature-reactive ink (for example, on the front of a label), as already mentioned above, which then releases a security characteristic in the printed form of the resistor or an additional print, and thereby a product certification (authentication) for the customer is obtained. This heat source (resistor) can be identified by means of special coding (product name, numbers, etc.), which produces information in the shape of the resistor by means of screen-printing or laser printing, using thermographic reading units.

The temperature-reactive ink or the temperature-reactive region can additionally be camouflaged with a paint coating or a security hologram, so that manipulation is prevented. The camouflage paint coating or security hologram is only removed when product certification (authentication) takes place in front of the customer.

After product authentication, purchase and automatic recording of the information in the cash register, the LCR oscillating circuit combination can be destroyed, mechanically or electrically, by introducing an appropriately excessive high frequency.

The LCR combination can also be attached to products as a hang tag to be left with the dealer after being removed. The dealer can use the hang tag for internal account settlement and then send it back to the manufacturer. This hinders the possibility of undesirable analysis by outside parties.

The LCR combination can also be coordinated to be operated alone, with different frequencies. The passive elements described are selected in such a way that the RF anti-theft devices, which are currently in use, react to these LCR combinations.

Using the LCR combination, it is possible to create a cost-effective anti-forgery and anti-theft device, which can be expanded by means of special high-frequency transmitters/readers, by means of printing techniques, by means of optical codings, the use of account settlement software with PCs, and by means of chip cards, to produce a high-tech anti-forgery and anti-theft system for secured documents

### THE DRAWINGS

FIG. 1 is a cross-sectioned view of a secured document according to a preferred embodiment of the invention;

FIG. 2 is a top view of the secured document as it appears prior to exposure by electromagnetic radiation;

FIG. 3 is a top view of the secured document showing a pattern produced in accordance with the invention when the document is exposed to electromagnetic radiation; and

FIGS. 4A and 4B show representative LCR circuits that can be used in accordance with the invention.

### DETAILED DESCRIPTION

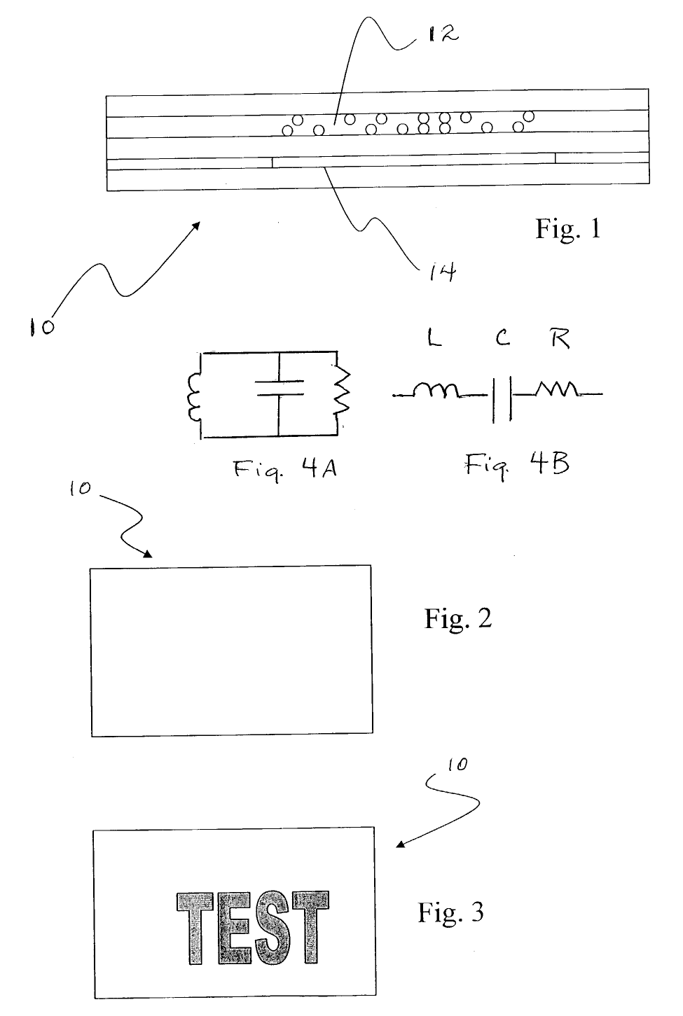

FIG. 1 illustrates a secured document 10 which is shown consisting of five layers of paper or plastic material or a combination thereof. The layer 12 contains thermochromic pigments. An LCR oscillating circuit 14 is embedded in a layer beneath the thermochromic pigment 12.

The thermochromic pigment 12 may be conventional pigment of the type which are available in a variety of ink, paint and plastic resin concentrates. For example, such pigments are sold by Chromatic Technologies, Inc. under the trademark Chromicolor™.

As shown in FIG. 2, the thermochromic pigment 12 normally is not visible, but when the secured document is placed in an appropriate electromagnetic field, the pigments change color because of the power dissipated in the resistor in the LCR circuit 14. This causes selected indicia (in this case the word “test”) to become visible as shown in FIG. 3. The thermochromic element may be used to provide machine readable codes (e.g. bar codes), product information, pictures or symbols of any description).

FIGS. 4A and 4B show examples of LCR circuits that may be used in accordance with the invention. Other circuit arrangements are also contemplated. In practice, there are numerous acceptable forms, dimensions, structures, designs, materials, production methods, etc. that can be used in accordance with the invention.

Instead of providing the thermochromic pigment in the form of the selected indicia, the indicia may be printed on the secured document beneath a thermochromic layer which is opaque in the absence of heat, but becomes transparent when heated, causing the printed information to become visible.

Multiple LCR oscillating circuits may be applied to or embedded within the secured document. The individual LCR circuits may respond to different frequencies which would enable multiple indicia or groups thereof to be selectively displayed. The use of multiple LCR oscillating circuits would also enhance protection against forgery.

It is not necessary that thermochromic pigments be used to practice the invention. Instead, thermographic devices may be provided for scanning the secured document when it is placed in the electromagnetic field. A thermographic measuring device usable for this purpose is an infrared video camera. Suitable devices of this type are commercially available. The dissipation of power in the resistor of the LCR oscillating circuit produces heat which in turn produces an infrared image that can be detected by the IR video camera producing a high definition video image of the resistor in the LCR circuit. The resistor can be shaped to produce a predetermined indicium (or indicia) to authenticate the secured document.

The LCR oscillating circuit 14 may be applied to the secured document 10 in a number of different ways. Preferably, the circuit is printed on the document using printing techniques which are well known in the art. It is also possible to form the LCR oscillating circuit on a foil which can then be placed within the secured document (as shown in FIG. 1) or laminated to an exposed surface of the document.

There currently exist anti-theft systems in which two antennas are detuned if an LC oscillating circuit passes between them. Anti-theft systems of this general type can be used with the LCR circuit of the invention, but the use of the resistor in accordance with the invention provides important additional security features due to the generation of heat. The amount of heat generated, the location of the heat generating unit and/or the shape of the heat generating unit can be measured in order to corroborate the authenticity of the document.

1. A secured document having an authenticity element comprising at least one LCR oscillating circuit, said circuit adapted to generate heat when radiated by electromagnetic energy due to the power dissipation of the resistor in the LCR oscillating circuit.

2. A secured document according to claim 1, including a thermochromic pigment within or on the secured document, said thermochromic pigment adapted to change color when subjected to heat generated by said LCR oscillating circuit.

3. A secured document according to claim 2, wherein the color change of the thermochromic pigment is irreversible.

4. A secured document according to claim 2, including a plurality of thermochromic pigments, each of said pigments providing a different color change when subjected to heat.

5. A secured document according to claim 2, wherein the thermochromic pigment changes from an invisible to a visible color.

6. A secured document according to claim 2, wherein the thermochromic pigment changes color from a visible to an invisible color.

7. A secured document according to claim 2, wherein the color change of the thermochromic pigment occurs in the visible range.

8. A secured document according to claim 2, wherein the thermochromic change of the color pigment is detectable by an automated color measuring device.

9. A secured document according to claim 2, wherein machine readable codings are released by means of the color change

10. A secured document according to claim 2, wherein the thermochromic pigments are camouflaged with a removable paint coating or a security hologram.

11. A secured document according to claim 1, wherein more than one LRC oscillating circuit is provided, each of which can be excited by the electromagnetic radiation source at different frequencies.

12. A secured document according to claim 1, wherein the LCR oscillating circuit can be excited at a frequency of the electromagnetic radiation source in the mega-hertz range (MHz).

13. A secured document according to claim 1, wherein the inductive (L) and/or the capacitative (C) and/or the resistive (R) components of the LCR oscillating circuit can be pre-adjusted once or can be permanently varied.

14. A secured document according to claim 2, wherein the resistive component (R) of the LCR oscillating circuit is provided in the form of a machine-readable coding.

15. A secured document according to claim 1, wherein the LCR oscillating circuit is applied in the form of a film or as an imprint on the secured document.

16. A secured document according to claim 1, in combination with a thermographic measuring device for measuring the heat generated by the LCR circuit.
